(19) United States
(12) Patent Application Publication
(10) Pub. No.: US 2015/0371418 A1
(43) Pub. Date: Dec. 24, 2015

(54) APPARATUS AND METHOD FOR VISUALIZATION OF OPTIMUM OPERATING ENVELOPE

(71) Applicant: Honeywell International Inc., Morristown, NJ (US)

(72) Inventors: Graeme Laycock, Hunters Hill (AU); David Barry Granatelli, Lilyfield (AU); Jaimal Arblaster, North Ryde (AU); Marek Klus, Dulwich Hill (AU)

(21) Appl. No.: 14/553,843

(22) Filed: Nov. 25, 2014

Related U.S. Application Data
(60) Provisional application No. 62/013,987, filed on Jun. 18, 2014.

(51) Int. Cl. G06T 11/20

(52) U.S. Cl. CPC G06T 11/206

(57) ABSTRACT

A method includes identifying an envelope associated with a process variable in an industrial process control and automation system. The envelope is defined by an upper limit and a lower limit on the process variable. The method also includes generating a graphical display for presentation to an operator. The graphical display identifies a trend of a value of the process variable over time and the upper and lower limits of the envelope over time. The graphical display could also identify predicted upper and lower limits of the envelope a predicted target value of the process variable over a future time period. The graphical display could further identify when the value of the process variable falls outside the envelope.

### CROSS-REFERENCE TO RELATED APPLICATION AND PRIORITY CLAIM

This application claims priority under 35 U.S.C. §119(e) to U.S. Provisional Patent Application No. 62/013,987 filed on Jun. 18, 2014. The above-identified provisional patent application is hereby incorporated by reference in its entirety.

### TECHNICAL FIELD

This disclosure relates generally to industrial process control and automation systems. More specifically, this disclosure relates to an apparatus and method for visualization of an optimum operating envelope.

### BACKGROUND

Industrial processes are commonly controlled and monitored via computer-based control systems. These control systems typically provide information to human operators who control the industrial processes. The ease with which human operators can assimilate and respond appropriately to changing process conditions is often important or critical to the efficient and safe running of the industrial processes.

A human operator often has access to current values of key process variables and sometimes historical trends of the key process variables, along with some definitions of desired future target values of the process variables that are typically delivered independently. The operator usually attempts to guide a monitored process to a new process state in a way that both maximizes the efficiency of the process and minimizes wear and tear on process equipment.

### SUMMARY

This disclosure provides an apparatus and method for visualization of an optimum operating envelope.

In a first embodiment, a method includes identifying an envelope associated with a process variable in an industrial process control and automation system. The envelope is defined by an upper limit and a lower limit on the process variable. The method also includes generating a graphical display for presentation to an operator. The graphical display identifies a trend of a value of the process variable over time and the upper and lower limits of the envelope over time.

In a second embodiment, an apparatus includes at least one memory configured to store information associated with a process variable in an industrial process control and automation system. The apparatus also includes at least one processing device configured to identify an envelope associated with the process variable using the information and generate a graphical display for presentation to an operator. The envelope is defined by an upper limit and a lower limit on the process variable. The graphical display identifies a trend of a value of the process variable over time and the upper and lower limits of the envelope over time.

In a third embodiment, a non-transitory computer readable medium embodies a computer program. The computer program includes computer readable program code for identifying an envelope associated with a process variable in an industrial process control and automation system. The envelope is defined by an upper limit and a lower limit on the process variable. The computer program also includes computer readable program code for generating a graphical display for presentation to an operator. The graphical display identifies a trend of a value of the process variable over time and the upper and lower limits of the envelope over time.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example device that generates or presents a graphical display containing a trend diagram according to this disclosure;

FIGS. 3 through 5 illustrate example trend diagrams according to this disclosure; and

FIG. 6 illustrates an example method for visualization of an optimum operating envelope according to this disclosure.

### DETAILED DESCRIPTION

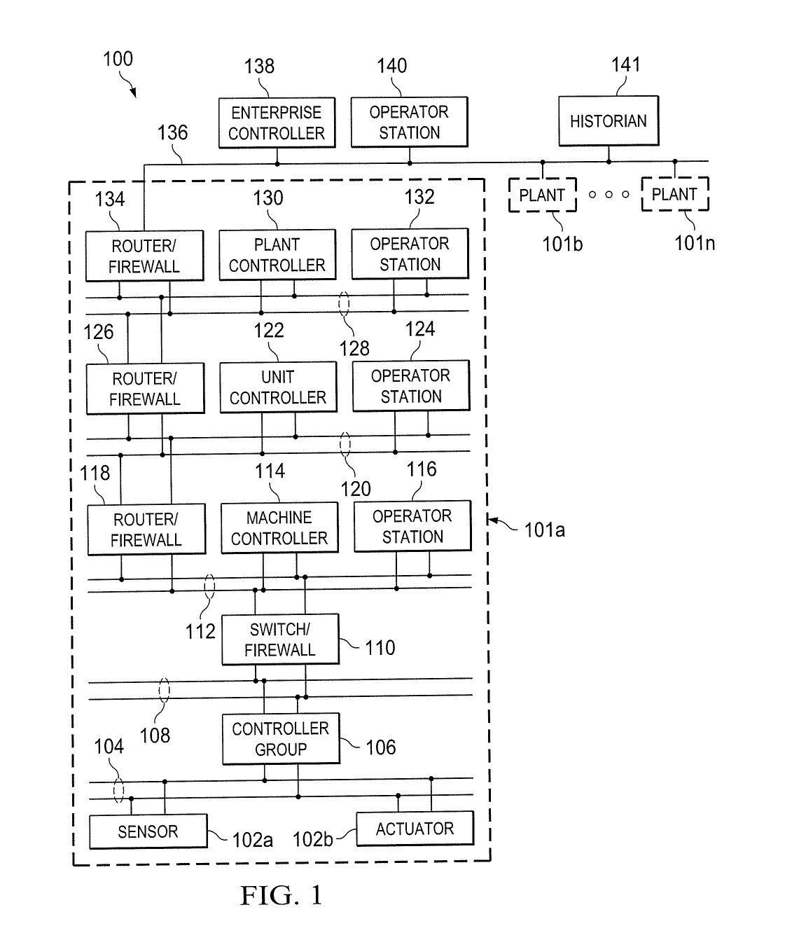

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

Redundant networks 104 are coupled to the sensors 102a and actuators 102b. The networks 104 facilitate interaction with the sensors 102a and actuators 102b. For example, the networks 104 could transport measurement data from the sensors 102a and provide control signals to the actuators 102b. The networks 104 could represent any suitable redundant networks. As particular examples, the networks 104 could represent redundant IEC-61850, IEC-62439, Ethernet/IP (EIP), or MODBUS/TCP networks. The networks 104 can have any suitable configuration, such as a parallel or ring topology.

In the Purdue model, “Level 1” includes one or more controller groups 106, which are coupled to the networks 104. Among other things, each controller group 106 may use the measurements from one or more sensors 102a to control the operation of one or more actuators 102b. Each controller in the controller groups 106 includes any suitable structure for controlling one or more aspects of a process system. As a particular example, each controller in the controller groups 106 could represent a computing device running a real-time operating system.

Redundant networks 108 are coupled to the controller groups 106. The networks 108 facilitate interaction with the controller groups 106, such as by transporting data to and from the controller groups 106. The networks 108 could represent any suitable redundant networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controller groups 106, sensors 102a, and actuators 102b, which could be associated with a particular piece of industrial equipment (such as a boiler or other machine). For example, the machine-level controllers 114 could log information collected or generated by the controller groups 106, such as measurement data from the sensors 102a or control signals for the actuators 102b. The machine-level controllers 114 could also execute applications that control the operation of the controller groups 106, thereby controlling the operation of the actuators 102b. In addition, the machine-level controllers 114 could provide secure access to the controller groups 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controller groups 106, sensors 102a, and actuators 102b).

One or more operator stations 116 are coupled to the networks 112. The operator stations 116 represent computing or communication devices providing user access to the machine-level controllers 114, which could then provide user access to the controller groups 106 (and possibly the sensors 102a and actuators 102b). As particular examples, the operator stations 116 could allow users to review the operational history of the sensors 102a and actuators 102b using information collected by the controller groups 106 and/or the machine-level controllers 114. The operator stations 116 could also allow the users to adjust the operation of the sensors 102a, actuators 102b, controller groups 106, or machine-level controllers 114. In addition, the operator stations 116 could receive and display warnings, alerts, or other messages or displays generated by the controller groups 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controller groups 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

A historian 141 is also coupled to the network 136 in this example. The historian 141 could represent a component that stores various information about the system 100. The historian 141 could, for example, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

As described above, industrial processes are commonly controlled and monitored via computer-based control systems, and these control systems typically provide information to human operators who control the industrial processes. In accordance with this disclosure, a graphical display is generated for presentation to an operator, such as via an operator station 116, 124, 132, 140. The graphical display includes a trend diagram, which provides the operator with an integrated graphical view of current and historical values of a key process variable (defining a trend). Future predicted values of the process variable could optionally be included in the trend diagram.

The trend diagram also includes current, historical, and possibly future values of an optimum operating envelope for the process variable. The operating envelope is defined by high and low limits for the process variable. The optimum operating envelope can be calculated in any suitable manner, such as from a defined set of limits. The resulting envelope is presented to the operator overlaid with the current, historical, and possibly future values of the process variable itself. An indicator can be used to identify when a value of the process variable has fallen, is falling, or is predicted to fall outside of the operating envelope.

The trend diagram could further include a target or desired value of the process variable, such as a setpoint for the process variable. The target or desired value of the process variable typically varies over time, and historical and current target or desired values of the process variable and possibly estimated future target or desired values of the process variable could be shown in the graphical display.

The graphical display could include a single trend diagram for a single variable or multiple trend diagrams for multiple variables. When multiple trend diagrams are generated, the multiple diagrams can be presented to the, operator integrated with the key process variables in a single graphical view. The multiple variables shown in a graphical display could be related to one another, such as when the variables relate to the same unit or other component of an industrial facility. In addition, multiple graphical displays could be generated for multiple groups of process variables, such as for different units or other components of an industrial facility.

This approach allows an operator to more easily identify if a process variable is trending towards a value that violates the variable's operating envelope. This then allows the operator to take corrective action, such as to intervene and adjust the industrial process so that the process variable stays within its envelope. Among other benefits, this helps to improve production efficiency and increase longevity of process equipment. In some embodiments, the control system (such as via an operator station 116, 124, 132, 140) annunciates visually and optionally audibly if a process variable value violates or is predicted to violate either its upper or lower limit. This can be valuable in a variety of ways, such as during process changes like equipment startups or grade changes.

The functionality for generating and presenting one or more trend diagrams can be implemented in any suitable manner. For example, this functionality could be implemented as one or more software routines executed by the operator stations 116, 124, 132, 140. Other approaches could also be used, such as when this functionality is implemented as one or more software routines executed by a server, which can generate the graphical displays and provide the graphical displays to the operator stations 116, 124, 132, 140 for presentation.

Although FIG. 1 illustrates one example of an industrial process control and automation system 100, various changes may be made to FIG. 1. For example, industrial control and automation systems come in a wide variety of configurations. The system 100 shown in FIG. 1 is meant to illustrate one example operational environment in which trend diagrams can be used. However, FIG. 1 does not limit this disclosure to any particular configuration or operational environment. Also, the trend diagrams described in this patent document could be used for various purposes and need not necessarily be used to allow a human operator to manually adjust an industrial process.

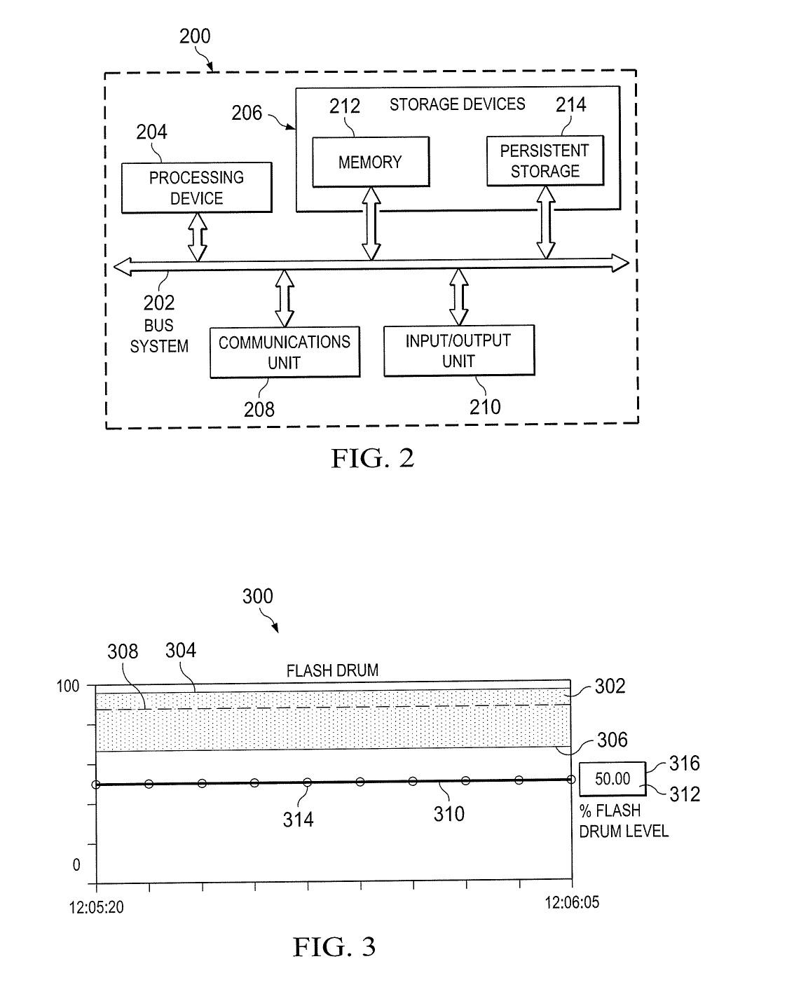

FIG. 2 illustrates an example device 200 that generates or presents a graphical display containing a trend diagram according to this disclosure. The device 200 could, for example, represent any suitable computing device in the system 100 of FIG. 1 used to generate at least one trend diagram.

As shown in FIG. 2, the device 200 includes a bus system 202, which supports communication between at least one processing device 204, at least one storage device 206, at least one communications unit 208, and at least one input/output (I/O) unit 210. The processing device 204 executes instructions that may be loaded into a memory 212. The processing device 204 may include any suitable number(s) and type(s) of processors or other devices in any suitable arrangement. Example types of processing devices 204 include microprocessors, microcontrollers, digital signal processors, field programmable gate arrays, application specific integrated circuits, and discrete circuitry.

The memory 212 and a persistent storage 214 are examples of storage devices 206, which represent any structure(s) capable of storing and facilitating retrieval of information (such as data, program code, and/or other suitable information on a temporary or permanent basis). The memory 212 may represent a random access memory or any other suitable volatile or non-volatile storage device(s). The persistent storage 214 may contain one or more components or devices supporting longer-term storage of data, such as a ready only memory, hard drive, Flash memory, or optical disc.

The communications unit 208 supports communications with other systems or devices. For example, the communications unit 208 could include a network interface card that facilitates communications over at least one Ethernet network. The communications unit 208 could also include a wireless transceiver facilitating communications over at least one wireless network. The communications unit 208 may support communications through any suitable physical or wireless communication link(s).

The I/O unit 210 allows for input and output of data. For example, the I/O unit 210 may provide a connection for user input through a keyboard, mouse, keypad, touchscreen, or other suitable input device. The I/O unit 210 may also send output to a display, printer, or other suitable output device.

In some embodiments, in order to generate a trend diagram, the device 200 could execute one or more software routines. For example, one software routine could be used to retrieve a set of defined limits and targets for a process variable over time and use that information to calculate the optimum operating envelope for the process variable over time. As a particular example, the optimum operating envelope could be determined as a range of values extending above and below the target or desired value for the process variable at any given point in time. Note that various techniques for identifying the operating envelope for a process variable could be used. Another software routine could be used to generate a diagram that shows the trending of historical, current, and possibly future high limit, low limit, current, and target or desired values for a process variable over time. At least one software routine could further be used to detect if and when the current value of a process variable exceeds its high or low limit and to make an annunciation, display a warning, or take other suitable action in response.

Although FIG. 2 illustrates one example of a device 200 that generates or presents a graphical display containing a trend diagram, various changes may be made to FIG. 2. For example, various components in FIG. 2 could be combined, further subdivided, or omitted and additional components could be added according to particular needs. Also, computing devices can come in a wide variety of configurations, and FIG. 2 does not limit this disclosure to any particular configuration of computing device.

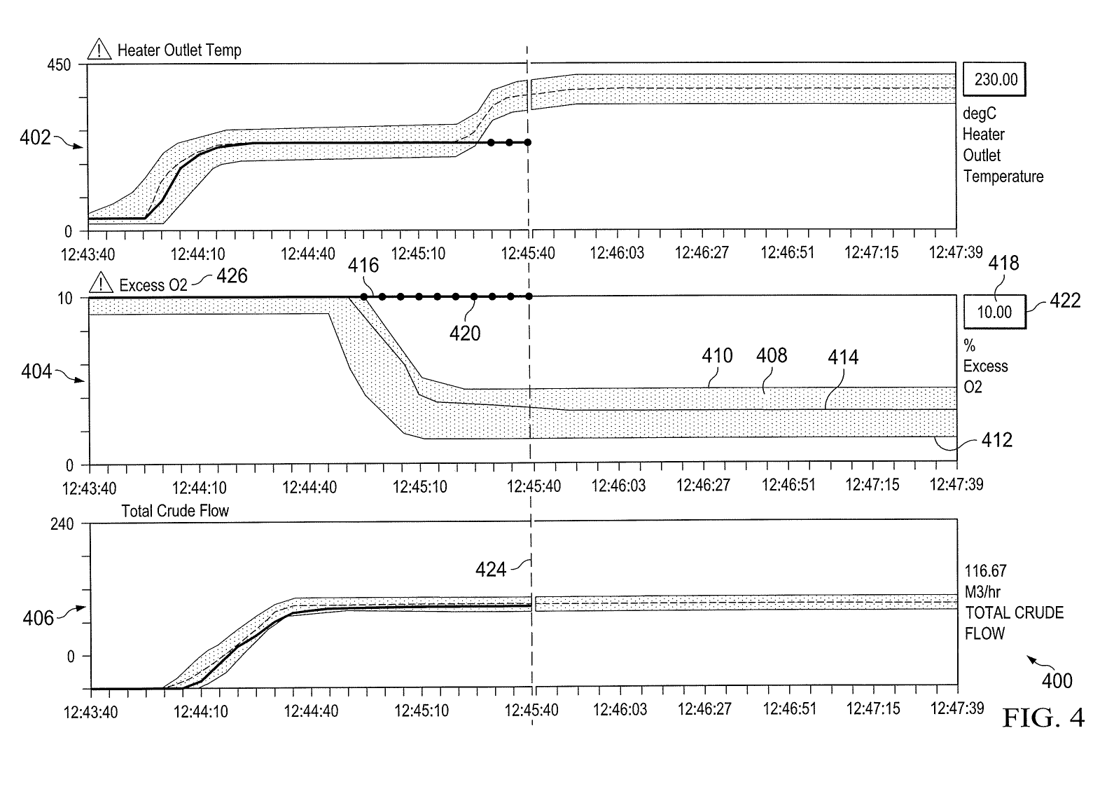

FIGS. 3 through 5 illustrate example trend diagrams according to this disclosure. The trend diagrams described here could be generated by the device 200 of FIG. 2 operating in the system 100 of FIG. 1. However, any suitable trend diagrams could be generated by any suitable devices that are operating in any suitable systems.

FIG. 3 illustrates an example trend diagram 300 with an operating envelope for a single process variable. As shown in FIG. 3, the trend diagram 300 includes a shaded region 302 that identifies the operating envelope of a specific process variable over time. The operating envelope is defined as the area between an upper limit 304 and a lower limit 306, which can be specified or identified in any suitable manner. A target or desired value of the process variable over time is denoted using a dot-dot-dash line 308, and the actual value of the process variable over time is denoted using a solid line 310. A current value of the process variable is identified using text 312 next to the graph. In the example shown in FIG. 3, dots 314 on the line 310 denote values of the process variable that fell outside the operating envelope at certain tick marks along a time axis. A box or other indicator 316 around the text 312 can also be used to denote that the current value of the process variable is outside the operating envelope.

In the example shown in FIG. 3, the operating envelope of the process variable is constant over the given period of time, although this need not be the case. Also, in the example shown in FIG. 3, the target or desired value of the process variable is constant over the given period of time, although this need not be the case. In addition, the actual value of the process variable is constant over the given period of time, although this need not be the case. Finally, note that the trend diagram 300 could be extended to encompass a future period of time, and some or all of the operating envelope, the target or desired value, and the actual value of the process variable could be predicted and displayed in the future period of time. One or more indicators could be used to distinguish between historical/current values and predicted values in the trend diagram 300, such as different shadings or colors or a vertical line identifying the current time (which therefore separates the historical values from the predicted future values).

FIG. 4 illustrates an example diagram 400 that displays target trends with operating envelopes for three process variables (heater outlet temperature, excess and total crude flow in this example). The diagram 400 includes three subsections 402-406, one for each process variable. Each subsection 402-406 could have the same characteristics as those described with respect to FIG. 3, including:
a shaded region 408, defined by an upper limit 410 and a lower limit 412, showing the operating envelope of a process variable over time;
a target or desired value of the process variable over time denoted using a dot-dot-dash line 414;
an actual value of the process variable over time denoted using a solid line 416;
a current value of the process variable denoted using text 418; and
dots 420 on the solid line 416 and a box or other indicator 422 around the text 418 to denote value(s) of the process variable falling outside the operating envelope.

In FIG. 4, the current time is 12:45:40, which is identified using an indicator 424. The diagram 400 shows that two of the three variables are currently outside their operating envelopes and have been for different lengths of time. Plotted information to the right of the current time (12:45:40) in the graphs shows the profiles of the estimated future limits and target or desired values of the three process variables.

A textual or other alert indicator 426 can also be provided if the current value of a process variable falls outside its envelope. The form of the indicator 426 could vary depending on the circumstances. For example, the indicator 426 could have one form for a warning and another form for an alarm (a warning identifies a less-severe condition while an alarm identifies a more-severe condition). As another example, the indicator 426 could have one pattern for an unacknowledged warning/alarm and an inverted pattern (such as inverted colors) for an acknowledged warning/alarm. Note, however, that any other suitable indicators 426 could be used.

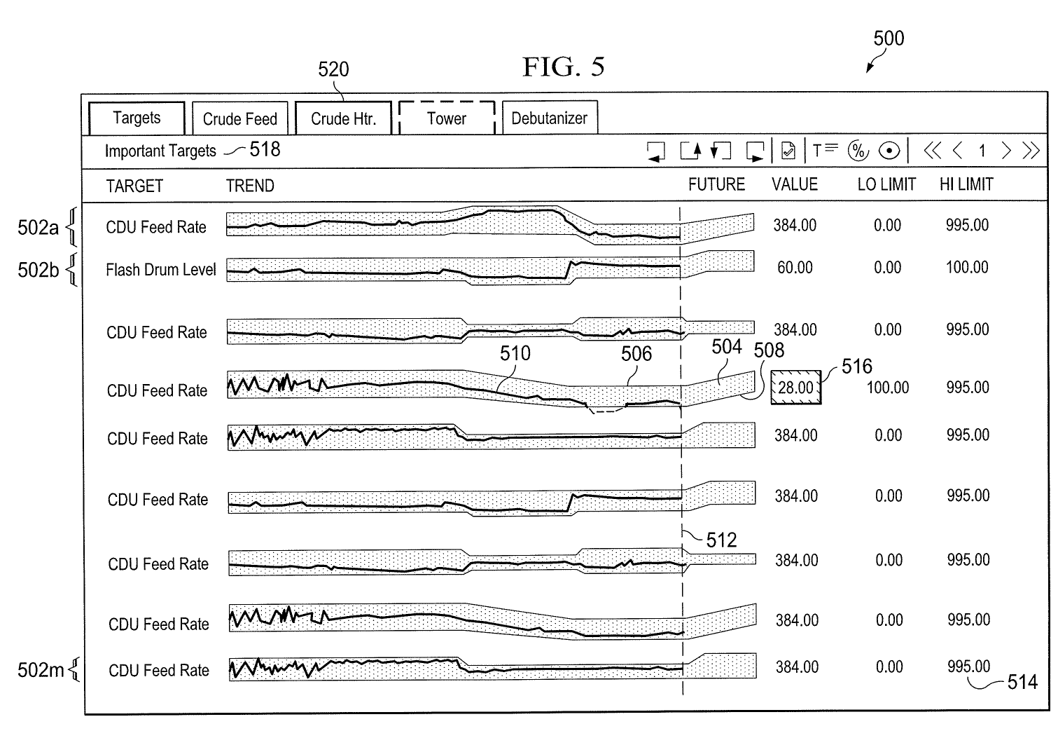

FIG. 5 illustrates another example diagram 500 that displays target trends with operating envelopes for multiple variables. The diagram 500 includes multiple subsections 502a-502m for different variables. Each subsection 502a-502m includes a shaded region 504 showing the operating envelope of the associated process variable over time (including the past envelope and the estimated future envelope). The envelope is defined by a high limit 506 and a low limit 508 of the process variable. Each subsection 502a-502m also includes a solid line 510 identifying the actual value of the process variable over time. An indicator 512 denotes the current time, and text 514 identifies the current value, current high limit value, and current low limit value of each process variable.

The current value of a process variable is flagged if the current value falls outside the process variable's limits. Note that rather than placing a box around the current value if the current value falls outside the limits, the diagram 500 highlights the entire cell 516 in which the current value is displayed. The cell 516 could be highlighted in any suitable manner, such as by using a different shading or color than the surrounding area. Also, the cell 516 could be highlighted in different ways, such as depending on whether the process variable is associated with a warning or an alarm.

A color or other indicator used with each solid line 510 could also vary depending on the circumstances. For example, each solid line 510 could have one color when inside the associated envelope and another color when outside the associated envelope. The color of a solid line 510 when outside the associated envelope could also vary depending on, for instance, whether the process variable was associated with a warning or an alarm during that time. While the target or desired value of each process variable over time is not shown in FIG. 5, the diagram 500 could include such information for each process variable.

Various tabs 518 can be provided that allow a user to select different groups of process variables to be displayed in the diagram 500. Note that different colored lines, shading, or other indicators 520 could be used to identify the status of the process variables associated with the tabs 518. For instance, a red outline could be used to identify a tab 518 having at least one process variable outside its envelope, and a blue outline could be used to identify the tab 518 that is currently selected.

Although FIGS. 3 through 5 illustrate examples of trend diagrams, various changes may be made to FIGS. 3 through 5. For example, the content and layout of each figure is for illustration only. Also, while the use of specific graphical elements (such as shading, solid and dot-dot-dash lines, dots, boxes, and colors) are described above, a graphical display can use a wide variety of characteristics to convey information to a user. The examples of the trend diagrams shown in FIGS. 3 through 5 do not limit the scope of this disclosure to particular graphical elements. In addition, note that any combination of features shown in FIGS. 3 through 5 could be used, such as when one or more features in one figure are combined with one or more features in another figure.

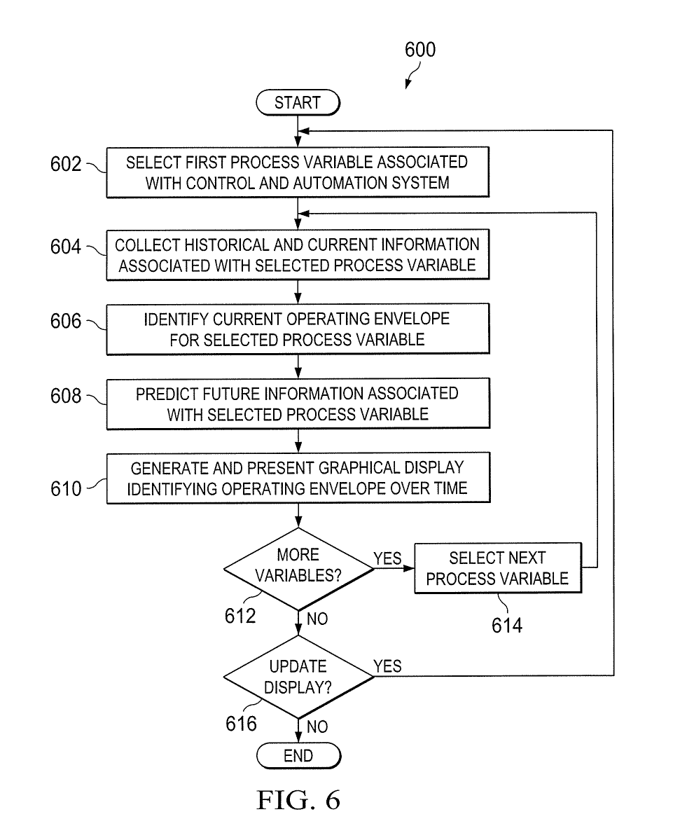

FIG. 6 illustrates an example method 600 for visualization of an optimum operating envelope according to this disclosure. For ease of explanation, the method 600 is described as being used by the device 200 of FIG. 2 in the system 100 of FIG. 1. However, the method 600 could be used by any suitable device in any suitable system.

As shown in FIG. 6, a first process variable associated with a control and automation system is selected at step 602. This could include, for example, the processing device 204 of an operator station, server, or other device selecting a process variable associated with a unit or other selected portion of an industrial facility.

Historical and current information associated with the selected process variable is collected at step 604. This could include, for example, the processing device 204 of the operator station, server, or other device retrieving historical actual values, setpoint values, and high/low limits of the selected process variable. This could also include the processing device 204 of the operator station, server, or other device identifying the current actual value and setpoint value of the process variable. This data could be retrieved from and stored in any suitable location(s), such as retrieved from the historian 141 or at least one process controller and stored in the memory 212.

A current operating envelope for the selected process variable is identified at step 606. This could include, for example, the processing device 204 of the operator station, server, or other device calculating the current envelope for the process variable based on various factors, such as processing equipment constraints, production requirements, alarm limits, or any other factors that can be used to define a range of acceptable values for the process variable. The current envelope could also be defined as one or more fixed percentages or amounts above and below the current setpoint value.

Future information associated with the selected process variable is predicted at step 608. This could include, for example, the processing device 204 of the operator station, server, or other device predicting the future values of the process variable, its setpoint, and/or the high and low limits of its operating envelope. A wide variety of techniques is known in the art for predicting information about a process variable, such as via the use of one or more models to predict the future behavior of an industrial process.

A graphical display is generated and presented to an operator at step 610. This could include, for example, the processing device 204 of the operator station, server, or other device generating a trend diagram that identifies the behavior of the selected process variable over time. The diagram could include historical, current, and possibly predicted future values of the process variable over the time period. The diagram could also include historical, current, and possibly predicted future high and low limits of the process variable's operating envelope over the time period. The diagram could further include historical, current, and possibly predicted future setpoint values of the process variable over the time period.

A determination is made whether more variables are to be presented in the graphical display at step 612. This could include, for example, the processing device 204 of the operator station, server, or other device determining whether a trend diagram has been generated for each process variable associated with the unit or other selected portion of the industrial facility. If so, the next process variable is selected at step 614, and the process returns to step 604 to generate a trend diagram for the next process variable.

Otherwise, trend diagrams for all variables have been generated, and a determination is made whether to update the display at step 616. This could include, for example, the processing device 204 of the operator station, server, or other device determining whether the operator has selected an option to continuously or non-continuously update the trend diagram(s) for the selected process variable(s). If so, the process returns to step 602 where each process variable is reselected and its trend diagram is updated.

Although FIG. 6 illustrates one example of a method 600 for visualization of an optimum operating envelope, various changes may be made to FIG. 6. For example, while shown as a series of steps, various steps in FIG. 6 could overlap, occur in parallel, occur in a different order, or occur multiple times. As a particular example, multiple variables could be processed in parallel without the need to select and process one variable at a time.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
identifying an envelope associated with a process variable in an industrial process control and automation system, the envelope defined by an upper limit and a lower limit on the process variable; and
generating a graphical display for presentation to an operator, the graphical display identifying a trend of a value of the process variable over time and the upper and lower limits of the envelope over time.

2. The method of claim 1, further comprising:
identifying predicted upper and lower limits of the envelope over a future time period;
wherein the graphical display further identifies the predicted upper and lower limits of the envelope over the future time period.

3. The method of claim 1, wherein the graphical display further identifies a target value for the process variable over time.

4. The method of claim 3, further comprising:
identifying a predicted target value of the process variable over a future time period;
wherein the graphical display further identifies the predicted target value of the process variable over the future time period.

5. The method of claim 1, wherein the graphical display further identifies when the value of the process variable falls outside the envelope.

6. The method of claim 5, further comprising:
generating a notification in response to determining that the value of the process variable falls outside the envelope.

7. The method of claim 1, wherein:
the method comprises identifying multiple envelopes associated with multiple process variables in the industrial process control and automation system; and
the graphical display identifies trends in values of the multiple process variables over time and the multiple envelopes over time.

8. The method of claim 7, wherein the multiple process variables are associated with a selected portion of an industrial facility.

9. An apparatus comprising:
at least one memory configured to store information associated with a process variable in an industrial process control and automation system; and
at least one processing device configured to:
identify an envelope associated with the process variable using the information, the envelope defined by an upper limit and a lower limit on the process variable; and
generate a graphical display for presentation to an operator, the graphical display identifying a trend of a value of the process variable over time and the upper and lower limits of the envelope over time.

10. The apparatus of claim 9, wherein:
the at least one processing device is further configured to identify predicted upper and lower limits of the envelope over a future time period; and
the graphical display further identifies the predicted upper and lower limits of the envelope over the future time period.

11. The apparatus of claim 9, wherein the graphical display further identifies a target value for the process variable over time.

12. The apparatus of claim 11, wherein:
the at least one processing device is further configured to identify a predicted target value of the process variable over a future time period; and
the graphical display further identifies the predicted target value of the process variable over the future time period.

13. The apparatus of claim 9, wherein the graphical display further identifies when the value of the process variable falls outside the envelope.

14. The apparatus of claim 13, wherein:
the graphical display further comprises text identifying a current value of the process variable; and
the at least one processing device is further configured to generate an indicator associated with the text in the graphical display in response to determining that the current value of the process variable falls outside the envelope of the process variable.

15. The apparatus of claim 13, wherein:
the graphical display comprises a line identifying the trend of the value of the process variable over time; and
the at least one processing device is further configured to vary at least one characteristic of the line to identify when the value of the process variable falls outside the envelope of the process variable.

16. A non-transitory computer readable medium embodying a computer program, the computer program comprising computer readable program code for:
identifying an envelope associated with a process variable in an industrial process control and automation system, the envelope defined by an upper limit and a lower limit on the process variable; and
generating a graphical display for presentation to an operator, the graphical display identifying a trend of a value of the process variable over time and the upper and lower limits of the envelope over time.

17. The computer readable medium of claim 16, wherein:
the computer program further comprises computer readable program code for identifying predicted upper and lower limits of the envelope over a future time period; and
the graphical display further identifies the predicted upper and lower limits of the envelope over the future time period.

18. The computer readable medium of claim 16, wherein:
the computer program further comprises computer readable program code for identifying a predicted target value of the process variable over a future time period; and
the graphical display further identifies the predicted target value of the process variable over the future time period.

19. The computer readable medium of claim 16, wherein the graphical display further identifies when the value of the process variable falls outside the envelope.

20. The computer readable medium of claim 19, wherein the graphical display is configured to identify both (i) one or more time periods during which historical values of the process variable fell outside the envelope and (ii) a current value of the process variable that is falling outside the envelope.
